(19) United States
(12) Patent Application Publication
(10) Pub. No.: US 2005/0287833 A1
(43) Pub. Date: Dec. 29, 2005

(54) Light-emitting-diode structure and fabrication method thereof

(76) Inventor: Chih-Ming Hsu, Taoyuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/167,213

(22) Filed: Jun. 28, 2005

(30) Foreign Application Priority Data
Jun. 29, 2004 (TW) 093118992

(51) Int. Cl. H01R 12/00

(52) U.S. Cl. 439/66

(57) ABSTRACT

The present invention discloses a light-emitting-diode structure and a fabrication method thereof, wherein firstly, a substrate and a printed circuit board are provided; an epitaxial layer and multiple LED dies are sequentially formed on the bottom surface of the substrate; two electrodes are formed on each LED die; multiple conductive lines penetrating through the printed circuit board are installed inside the printed circuit board; multiple junctions and multiple solder joints are separately formed on the top surface and the bottom surface of the printed circuit board; each junction is connected to its corresponding solder joint via one conductive line; the substrate is compressed to join to the printed circuit board at a high temperature and under a high pressure in order to enable each junction to join with the corresponding electrode of the LED die; and lastly, the joined substrate and printed circuit board is cut by each individual LED die into multiple LED structures. The present invention can reduce the cost, simplify the fabrication process, and raise the yield.

### BACKGROUND OF THE INVENTION

1. Field of the Invention

The present invention relates to a light-emitting-diode structure and a fabrication method thereof, particularly to a light-emitting-diode structure and a fabrication method thereof, which can save the packaging cost of light emitting diodes.

2. Description of the Related Art

Light emitting diode (LED) is a semiconductor and has a very extensive application realm. The light emitted by LED can be either visible or invisible. LED is a self-luminous element and has the advantages of long service life, high speed, low power consumption, and superior monochromaticity. With the development of high brightness red, yellow, and blue LED's, the LED market is expanding steadily. Currently, LED has been extensively used in many products, from household electrical appliances to various electronic products, such as large-size true-color display boards, information display panels, vehicles, scanners, signal lights, and backlight sources of mobile phones.

In the conventional LED packaging technology, an LED die is installed on a substrate via a wire bonding or a flip chip technology, and then, the LED die is further installed on a printed circuit board via soldering or a Surface Mount technology (SMT). However, such a kind of packaging method incurs high packaging cost, and the yield is also lowered by the complexity of the conventional fabrication process.

Therefore, the present invention proposes a light-emitting-diode structure and a fabrication method thereof to overcome the problems mentioned above.

### SUMMARY OF THE INVENTION

The primary objective of the present invention is to provide a light-emitting-diode structure and a fabrication method thereof, wherein LED dies are directly joined to the printed circuit board, which can save the packaging cost in the conventional technology and thus can lower the cost of LED.

Another objective of the present invention is to provide a light-emitting-diode structure and a fabrication method thereof, wherein LED dies are directly joined to the printed circuit board, which can simplify LED fabrication process and thus can raise LED yield.

To achieve the aforementioned objectives, the present invention proposes a light-emitting-diode structure, which comprises a substrate, with an epitaxial layer and an LED die having two electrodes sequentially formed on the bottom surface of the substrate; and a printed circuit board, having two junctions and two solder joints separately formed on the top surface and the bottom surface of the printed circuit board with two junctions respectively connected to their corresponding solder joints via two conductive lines penetrating the printed circuit board; wherein each junction of the printed circuit board is joined with the corresponding electrode of the LED die.

The present invention also proposes a fabrication method of the aforementioned light-emitting-diode structure, which comprises the following steps: firstly providing a substrate and a printed circuit board; sequentially forming an epitaxial layer and multiple LED dies on the bottom surface of the substrate; forming two electrodes on each LED die; separately forming multiple junctions and multiple solder joints on the top surface and the bottom surface of the printed circuit board; connecting the junctions to their corresponding solder joints via multiple conductive lines penetrating through the circuit board; compressing the substrate onto the printed circuit board to join each junction of the printed circuit board to its corresponding electrode of the LED die at a high temperature and under a high pressure; and lastly cutting the joined substrate and printed circuit board by each individual LED die into multiple LED structures.

### BRIEF DESCRIPTION OF THE DRAWINGS

FIG. 1 is a schematic diagram of the LED structure according to the present invention.

FIG. 2(a) to FIG. 2(c) are schematic structure diagrams showing the steps of the fabrication method according to the present invention.

FIG. 3 is a top view of the substrate and the printed circuit board according to the present invention.

FIG. 4 is a top view showing the joined substrate and printed circuit board according to the present invention.

FIG. 5 is a top view showing the division lines in the cutting step according to the present invention.

### DETAILED DESCRIPTION OF THE INVENTION

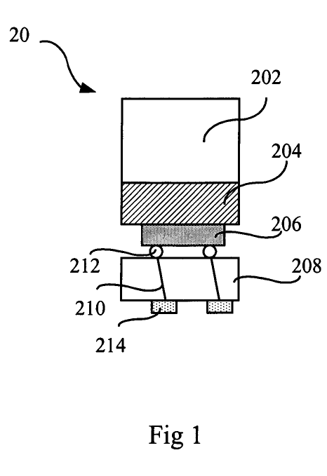

The present invention proposes a light-emitting-diode structure to overcome the problem of high LED packaging cost in the conventional technology. Refer to FIG. 1 a schematic diagram of the LED structure according to the present invention. The LED structure 20 of the present invention comprises a substrate 202, which may be made of sapphire; an epitaxial layer 204, formed on the bottom surface of the substrate 202; and an LED die 206, formed on the bottom surface of the epitaxial layer 204. The LED die 206 is electrically polarized to form two electrodes on the LED die 206 via plating a desired metallic layer, such as a titanium, aluminum, nickel-gold, indium, antimony, selenium, arsenic, beryllium, boron, cadmium, phosphorus, silicon, sulfur, tin, or zinc layer, on the substrate 202 or the epitaxial layer 204 with a physical method, such as vapor deposition, sputtering, or chemical vapor deposition. The LED structure 20 further comprises a printed circuit board 208, which has: two conductive lines 210, penetrating through the printed circuit board 208; two junctions 212, formed on the top surface of the printed circuit board 208; and two solder joints 214, formed on the bottom surface of the printed circuit board 208. The junctions 212 may be golden bumps, tin bumps, or anisotropic conductive glue. The junctions 212 of the printed circuit board 208 respectively connect with the corresponding electrodes of the LED die 206.

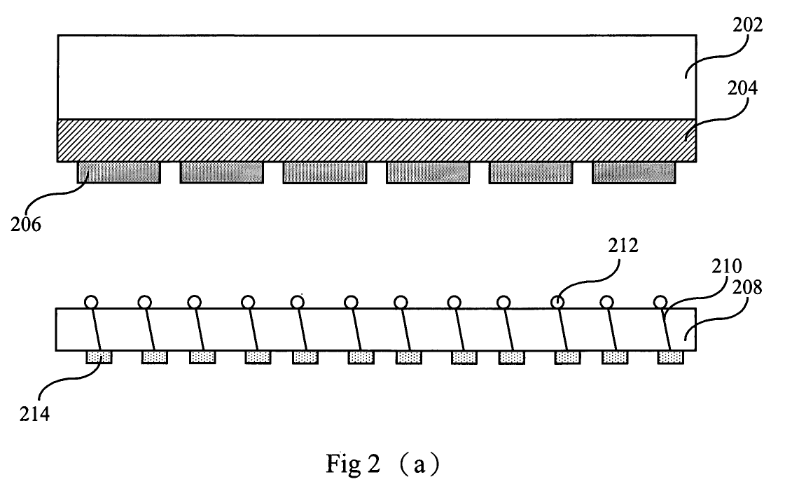

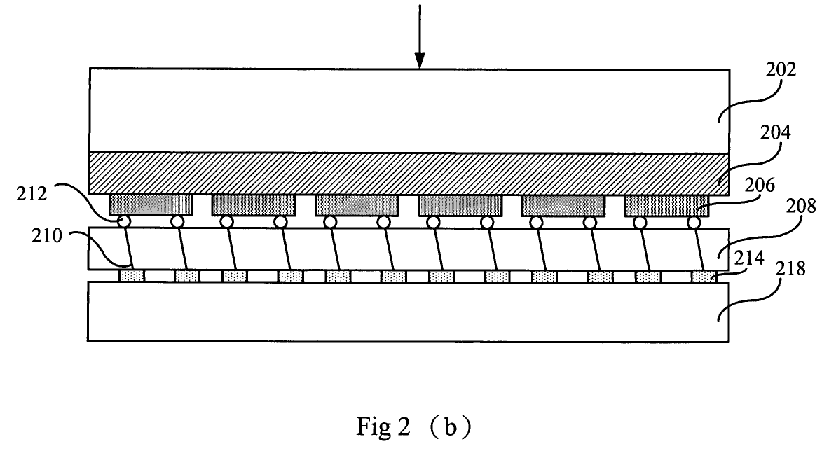

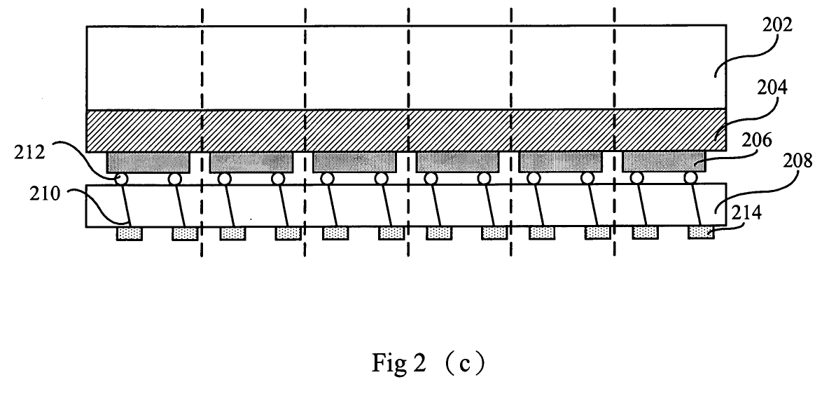

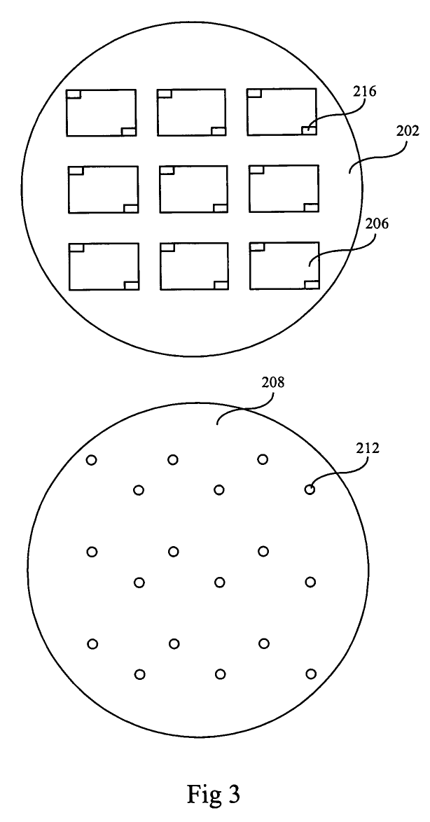

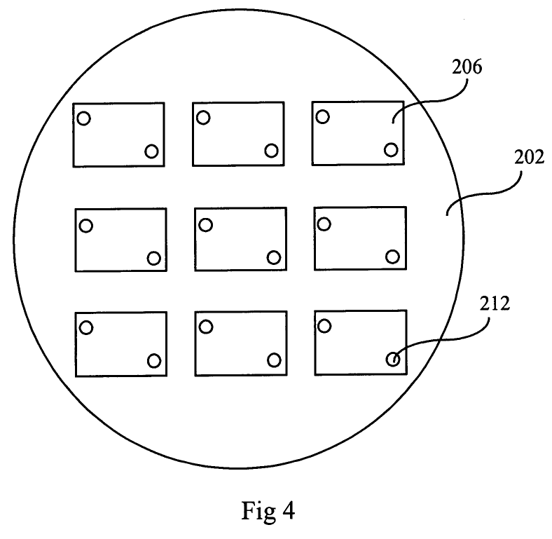

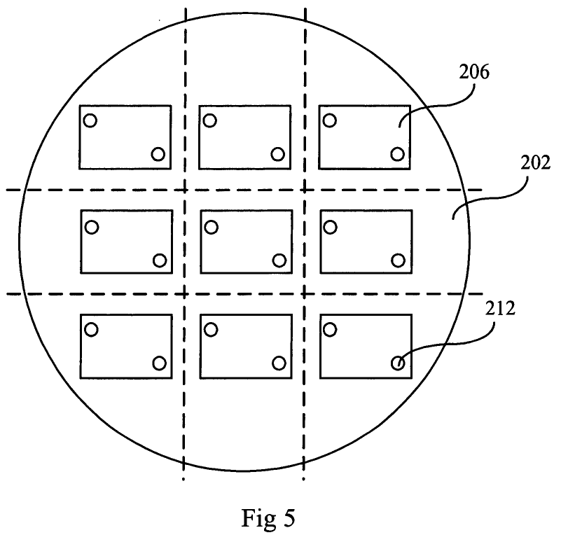

The present invention also proposes a fabrication method of the aforementioned light-emitting-diode structure. Refer to from FIG. 2(a) to FIG. 2(c) showing schematically the steps of the fabrication method according to the present invention. Firstly, a substrate 202 and a printed circuit board 208 are provided. Also referring to FIG. 3 the top view of the substrate 202 and the printed circuit board 208, an epitaxial layer 204 and multiple LED dies 206 are sequentially formed on the bottom surface of the substrate 202; two electrodes 216 are formed on each LED die 206; multiple conductive lines 210 penetrating through the printed circuit board 208 are installed inside the printed circuit board 208; multiple junctions 212 and multiple solder joints 214 are separately formed on the top surface and the bottom surface of the printed circuit board 208; each junction 212 is connected to its corresponding solder joint 214 via one conductive line 210. Referring to FIG. 2(b) and FIG. 4 another top view, the substrate 202 is compressed to join to the printed circuit board 208 on a heating platform 218 at a temperature ranging from 100 to 500° C. and under a pressure ranging from 0.5 to 50 kg/cm² in order to join each junction 212 with the corresponding electrode 216 of the LED die 206. Referring FIG. 2(c) and FIG. 5, the joined substrate 202 and printed circuit board 208 is cut by each individual LED die 206 into multiple LED structures 20 along division lines, such as the dashed lines on the drawings, via a laser cutting or a diamond cutter.

If thinner LED dies 206 are needed, the epitaxial layer 204 will be ground before cutting, and then, the joined substrate 202 and printed circuit board 208 is cut by each individual LED die 206 into multiple LED structures 20 via a laser cutting or a diamond cutter.

In summary, he present invention proposes a light-emitting-diode structure and a fabrication method thereof, wherein LED dies are directly joined to a printed circuit board, so that the cost expended in the packaging process of the conventional technology is saved, LED fabrication process is simplified, and LED yield is raised.

Those embodiments described above are to clarify the present invention to enable the persons skilled in the art to understand, make, and use the present invention but not intended to limit the scope of the present invention. Any equivalent modification and variation according to the spirit of the present invention disclosed herein is to be included within the scope of the present invention.

1. A a light-emitting-diode structure, comprising:
a substrate, wherein an epitaxial layer is formed on the bottom surface of said substrate, and a light-emitting-diode die is formed on the bottom surface of said epitaxial layer, and two electrode are formed on said light-emitting-diode die; and
a printed circuit board, wherein two conductive lines are installed to penetrate through said printed circuit board; two junctions and two solder joints are separately formed on the top surface and the bottom surface of said printed circuit board; said printed circuit board is joined to said two electrodes of said light-emitting-diode die via said two junctions; and said junctions are respectively connected to corresponding said solder joints via said conducive lines.

2. The light-emitting-diode structure according to claim 1, wherein said substrate is made of sapphire.

3. The light-emitting-diode structure according to claim 1, wherein said two junctions may be golden bumps, tin bumps, or anisotropic conductive glue.

4. A fabrication method of a light-emitting-diode structure, comprising the following steps:
providing a substrate and a printed circuit board, and forming an epitaxial layer and multiple light-emitting-diode dies in top-down sequence on the bottom surface of said substrate, and forming two electrodes on each said light-emitting-diode die, and installing multiple conductive lines penetrating through said printed circuit board, and forming multiple junctions and multiple solder joints, which interconnect with each other via said conductive lines, separately on the top surface and the bottom surface of said printed circuit board;
compressing said substrate to join to said printed circuit board at a high temperature and under a high pressure so that each said junction joins with its corresponding said electrode; and
cutting said joined substrate and printed circuit board by each individual said light-emitting-diode die into multiple light-emitting-diode structures.

5. The fabrication method of a light-emitting-diode structure according to claim 4, further comprising a step of grinding said epitaxial layer before said cutting step.

6. The fabrication method of a light-emitting-diode structure according to claim 4, wherein said high temperature ranges from 100 to 500° C.

7. The fabrication method of a light-emitting-diode structure according to claim 4, wherein said high pressure ranges from 0.5 to 50 kg/cm².

8. The fabrication method of a light-emitting-diode structure according to claim 4, wherein said cutting is performed with either a laser cutting or a diamond cutter.
